(19) United States
(12) Patent Application Publication
(10) Pub. No.: US 2013/0341449 A1
(43) Pub. Date: Dec. 26, 2013

(54) ANVIL UNIT FOR A MATERIAL REDUCING MACHINE

(71) Applicants: Darin Lyn Dux, Pella, IA (US); Josh Aaron Youngblut, Knoxville, IA (US); Christopher Ryan Sievers, Ankeny, IA (US); Keith Leon Roozeboom, Pella, IA (US); Duane Allen Harthoorn, Lynnville, IA (US); John Gary Gardner, Altoona, IA (US); Aaron Dean Lovell, Knoxville, IA (US)

(72) Inventors: Darin Lyn Dux, Pella, IA (US); Josh Aaron Youngblut, Knoxville, IA (US); Christopher Ryan Sievers, Ankeny, IA (US); Keith Leon Roozeboom, Pella, IA (US); Duane Allen Harthoorn, Lynnville, IA (US); John Gary Gardner, Altoona, IA (US); Aaron Dean Lovell, Knoxville, IA (US)

(73) Assignee: Vermeer Manufacturing Company, Pella, IA (US)

(21) Appl. No.: 13/991,039

(22) PCT Filed: Nov. 29, 2011
(86) PCT No.: PCT/US11/62322

§ 371 Date: Sep. 11, 2013

Related U.S. Application Data
(60) Provisional application No. 61/418,780, filed on Dec. 1, 2010.

(51) Int. Cl. B02C 13/282; B02C 13/09

(52) U.S. Cl. CPC B02C 13/282; B02C 13/09
USPC 241/222; 241/291; 29/592

(57) ABSTRACT

A reducing machine is disclosed. The reducing machine includes a rotational reducing component, a power in-feed system for feeding material toward the rotational reducing component, and a mill box at least partially surrounding the rotational reducing component. The reducing machine also includes an anvil unit that can be inserted into the mill box and removed from the mill box. The anvil unit includes a ramp that bridges a gap between the power in-feed and the rotational reducing component. The anvil unit also includes an anvil main body having a first end positioned adjacent the power in-feed and a second end positioned adjacent the rotational reducing component. The anvil unit further includes first and second spaced-apart shear edges positioned adjacent to the second end of the anvil main body. The first and second shear edges cooperate with the rotational reducing component to provide consecutive shearing actions as reducing elements of the rotational reducing component move initially past the first shear edge and then subsequently past the second shear edge.

This application is being filed on 29 Nov. 2011, as a PCT International Patent application in the name of Vermeer Manufacturing Company, a U.S. national corporation, applicant for the designation of all countries except the US, and Darin Lyn Dux, John Aaron Youngblut, Christopher Ryan Sievers, Keith Leon Roozeboom, Duane Allen Harthoorn, John Gary Gardner and Aaron Dean Lovell, citizens of the U.S., applicants for the designation of the US only, and claims priority to U.S. Provisional Patent Application Ser. No. 61/418,780, filed Dec. 1, 2010, which is incorporated herein by reference.

### TECHNICAL FIELD

The present disclosure relates generally to reducing machines. Particularly, the present disclosure relates to a reducing machine such as horizontal grinders.

### BACKGROUND

Reducing machines are machines used to grind, chip, shred or otherwise mechanically break-down larger pieces of material into smaller pieces of material. One common type of reducing machine is known as a horizontal grinder. A horizontal grinder typically includes a power in-feed mechanism that forces larger material (e.g., wood-based material such as tree trunks, tree branches, logs, etc.) into contact with a rotating grinding drum. The larger material is contacted by teeth carried by the grinding drum and portions of the material are forced past a fixed shear edge defined by an anvil of the horizontal grinder. Upon passing the fixed shear edge of the anvil, the material enters a grinding chamber defined at least in part by a sizing screen that extends around a portion of the grinding drum. Within the grinding chamber, the material is further reduced by the teeth carried by the grinding drum. Once the material within the grinding chamber is reduced to a certain particle size, the material is discharged through sizing openings of the sizing screen. Upon passing through the sizing openings of the sizing screen, the reduced material is typically deposited on a discharge conveyor that carries the reduced material to a collection location. An example horizontal grinder is disclosed at United States Patent Application Publication No. U.S. 2009/0242677, which is hereby incorporated by reference in its entirety.

### SUMMARY

One aspect of the present disclosure relates to an anvil unit adapted to be inserted into and removed from a reducing machine as a unit. In one embodiment, the anvil unit includes first and second spaced-apart shear edges.

Another aspect of the present disclosure relates to an anvil unit including an anvil main body (i.e., a base anvil) having a top side at which a ramp is located. One end of the anvil main body defines a step and a shelf. The step downwardly offsets the shelf of the anvil main body from the top side of the anvil main body. A top wear plate and a top shear edge defining plate are mounted to the top surface and cooperate to define a wear surface of the ramp. A lower shear edge defining plate is mounted to the shelf The top shear edge defining plate defines a first shear edge and the lower shear edge defining plate defines a second shear edge. The second shear edge is downwardly and outwardly offset from the first shear edge. In certain embodiments, both the upper and the lower shear edge defining plates are identical parts. In certain embodiments, both of the shear edge defining plates extend beyond sides of a mill box of a grinding machine and include outer portions that are clamped in position to secure the anvil unit at a fixed location with respect to the mill box.

A further aspect of the present disclosure relates to a shear edge defining plate that defines four shear edges, a central portion that is fastened to a mill box and end portions that are clamped to the mill box. The shear edge defining plate is configured such that the shear edge defining plate can be mounted in four different orientations. By changing orientations, previously used, worn shear edges can be successively replaced with unworn shear edges. Thus, each shear edge defining plate includes an initial shear edge and three replacement shear edges.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a perspective view of a horizontal grinder in accordance with the principles of the present disclosure;

FIG. 2 depicts a power feed, rotational reducing component and anvil unit of the horizontal grinder of FIG. 1;

FIG. 3 illustrates a mill box of the horizontal grinder of FIG. 1;

FIG. 4 is an enlarged view of a portion of FIG. 2 showing the anvil unit of the horizontal grinder bridging a gap between the power feed and the rotational reducing unit;

FIGS. 4A and 4B are further enlarged side views of the anvil unit of FIG. 4;

FIG. 5 illustrates an anvil receptacle of the mill box of FIG. 3;

FIG. 6 illustrates the anvil receptacle of FIG. 5 with the anvil unit of FIGS. 2 and 4 clamped therein;

FIG. 7 is a cross-sectional view taken along section lines 7-7 of FIG. 6;

FIG. 8 is a cross-sectional view taken along section lines 8-8 of FIG. 6;

FIG. 9 is an exploded perspective view of the anvil unit of FIGS. 2 and 4, the anvil unit is shown including an anvil main body, two shear edge defining plates and a top wear plate;

FIG. 10 is a top, plan view of the anvil main body of FIG. 9;

FIG. 11 is an end view of the anvil main body of FIG. 10;

FIG. 12 is a cross-sectional view taken along section line 12-12 of FIG. 11;

FIG. 13 is a plan view of one of the shear edge defining plates of the anvil unit of FIG. 9;

FIG. 14 is a side view of the shear edge defining plate of FIG. 9;

FIG. 15 shows a second anvil unit that can be used with the mill box of FIG. 3; and

FIG. 16 shows a third anvil unit that can be used with the mill box of FIG. 3.

### DETAILED DESCRIPTION

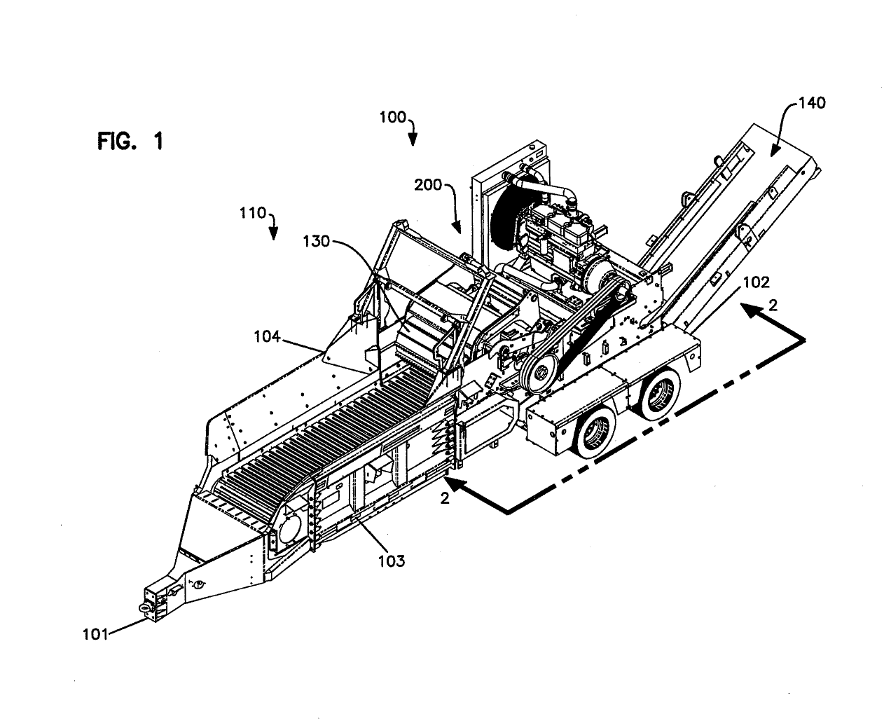

FIGS. 1-4 illustrate a reducing machine in accordance with the principles of the present disclosure. The reducing machine is depicted as a horizontal grinder 100 having a front end 101, a rear end 102, a left side 103 and a right side 104. The horizontal grinder 100 includes a power in-feed system 110, a reducing apparatus 200 (e.g., a comminution apparatus) and a discharge conveyor 140. The in-feed system 110 of the grinder 100 includes an in-feed table 120 and a feed roller 130. The reducing apparatus 200 of the grinder 100 includes a rotational reducing component 201 such as a rotary drum 202 which carries a plurality of reducing elements 203 (e.g., teeth, blades, etc.). During reducing operations, the rotational reducing component 201 is rotated about an axis of rotation 204 such that tips of the reducing elements 203 define a circumferential reducing path RP. The reducing apparatus 200 also include a sizing screen 210 that at least partially surrounds the rotational reducing component 201. A reducing chamber 205 is defined between the rotational reducing component 201 and the sizing screen 210. The reducing apparatus 200 further includes an anvil unit 220 having first and second shear edges 221, 223 positioned adjacent to an entry point 225 of the reducing chamber 205 at locations outwardly offset from the circumferential reducing path RP.

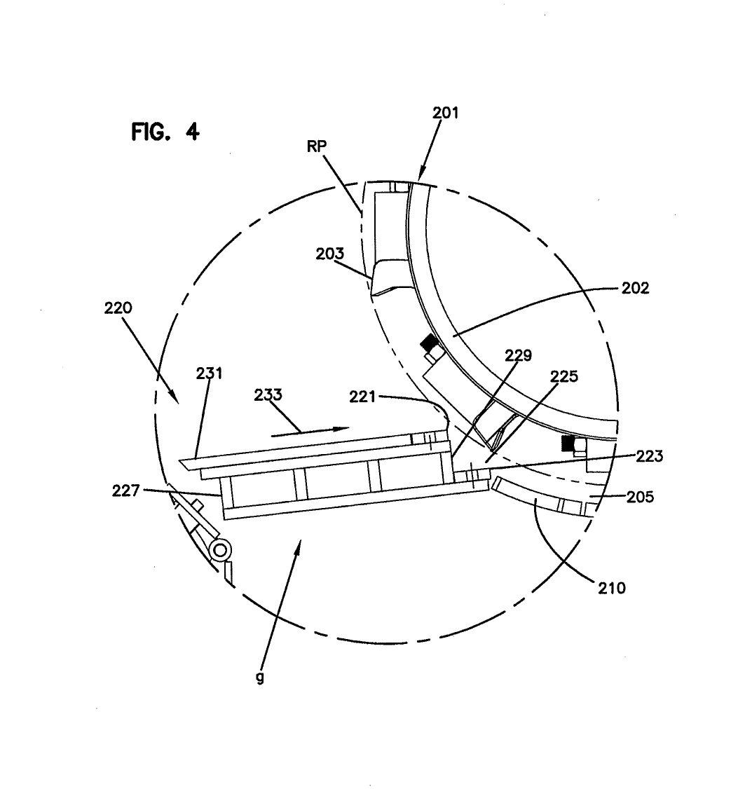

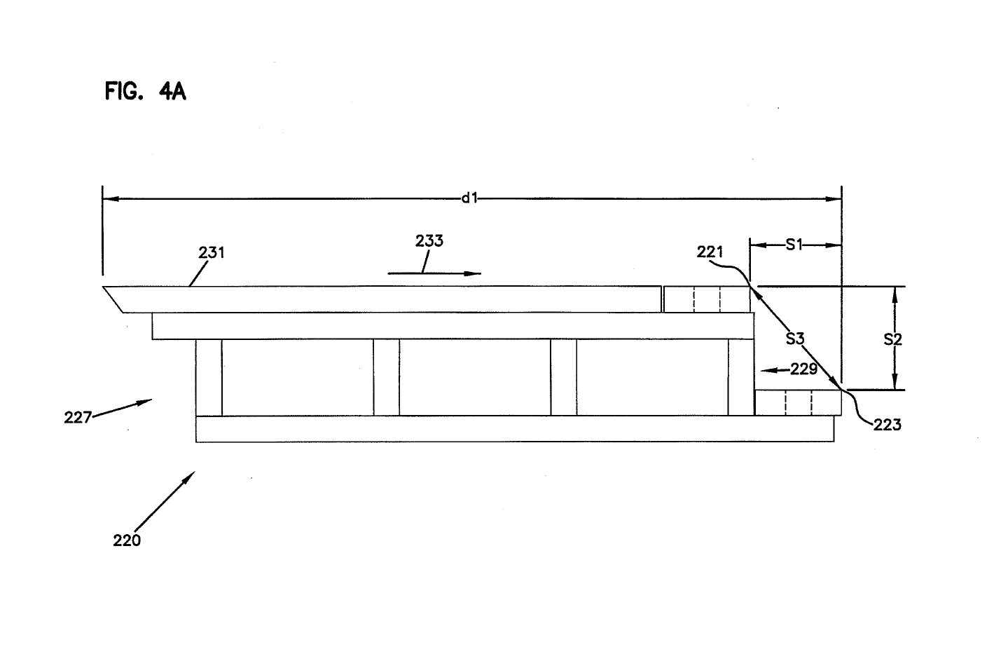

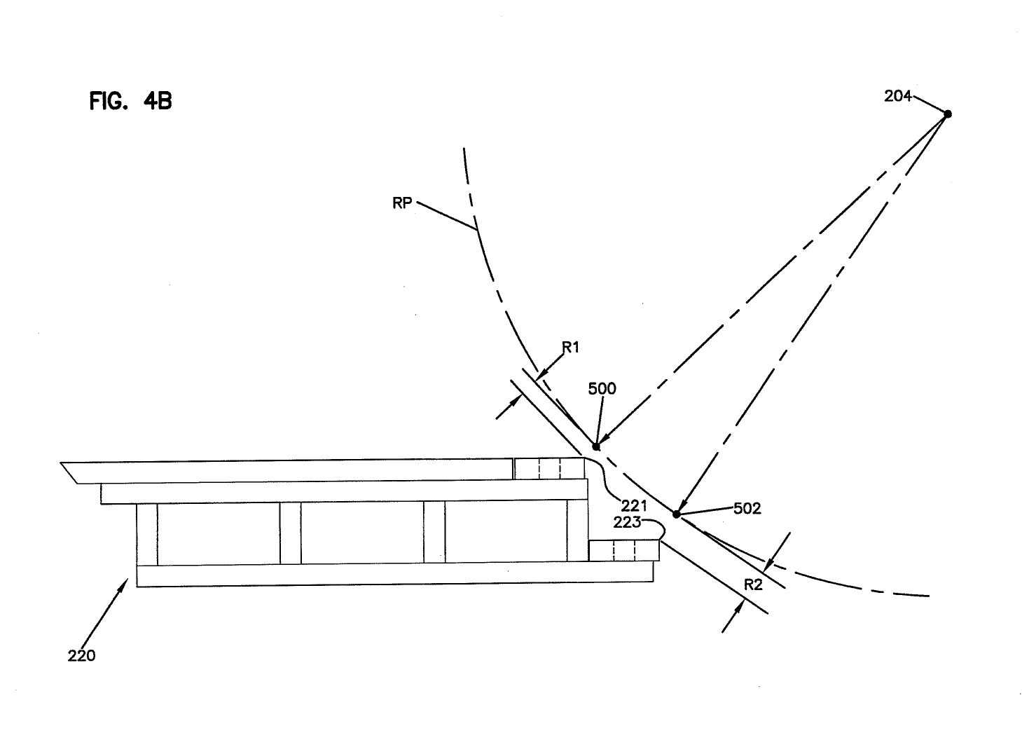

As shown at FIGS. 4, 4A and 4B, the anvil unit 220 has first and second ends 227, 229 separated by a first dimension dl. The first dimension dl is sufficiently large for the anvil unit 220 to substantially bridge a gap g between the feed table 120 and the rotational reducing component 201. The first end 227 is positioned adjacent to the feed table 120 and the second end 229 is positioned adjacent to the rotational reducing component 201. The shear edges 221, 223 are positioned at the second end 229 of the anvil unit 220. The anvil unit 220 defines a ramp 231 that extends in a direction 233 along a top side of the anvil unit from the first end 227 toward the second end 229 of the anvil unit 220. The direction 233 corresponds to a direction of travel of material desired to be reduced as the material is power fed by the power in-feed system 110 toward the rotational reducing component 201. The first and second shear edges 221, 223 are outwardly radially offset from the circumferential reducing path RP by radial offset distances R1, R2. In one embodiment, the radial offset distances R1, R2 are substantially equal to one another. In the depicted embodiment, the radial offset distances R1, R2 are different from one another. Referring to FIG. 4A, the second shear edge 223 is offset from first shear edge 221 by a spacing S1 measured along the direction 233, by a spacing S2 measured in a vertical direction and by a total spacing S3. As shown at FIG. 4B, the first shear edge 221 defines a first shear position 500 along the reducing path RP and the second shear edge 223 defines a second shear position 502 along the reducing path RP. The first and second shear positions 500, 502 are circumferentially offset from one another. The shear positions 500, 502 are the locations where radii drawn from the axis of rotation 204 to the shear edges 201, 203 intersect the reducing path RP.

In use of the horizontal grinder 100, material desired to be reduced (e.g., tree branches, trunks, logs, planks, wood strips, or other materials) are power fed by the in-feed system 110 toward the rotational reducing component 201. The power in-feed system 110 moves the material in the first direction 233 over the ramp 231 of the anvil unit 220 until the material intersects the circumferential reducing path RP. Upon intersection with the circumferential reducing path RP, the material is impacted by the reducing elements 203 of the rotational reducing component 201 and portions of the material are forced across the first and second shear edges 221, 223 where the material is reduced in size through a dual shearing action caused by the interaction of the shear edges 221, 223 and the reducing elements 203. The first and second shear edges 221, 223 cooperate with the rotational reducing component 201 to provide consecutive shearing actions as the reducing elements move initially past the first shear edge 221 and then subsequently past the second shear edge 223. After moving past the shear edges 221, 223, the material enters the reducing chamber 205 through the entry point 225. Within the reducing chamber 205, the material is further reduced through contact with the reducing elements 203 and through contact with the sizing screen 210. Pieces of material that are small enough to pass through the sizing screen are forced through the sizing screen and deposited on the discharge conveyor 140. The discharge conveyor 140 typically carries the reduced material to a desired collection location (e.g., a pile, bin, truck bed, etc.).

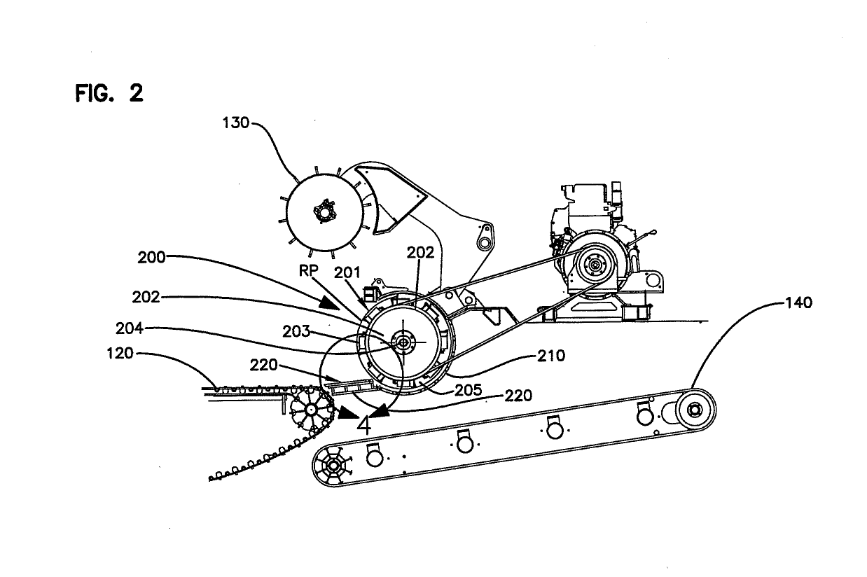

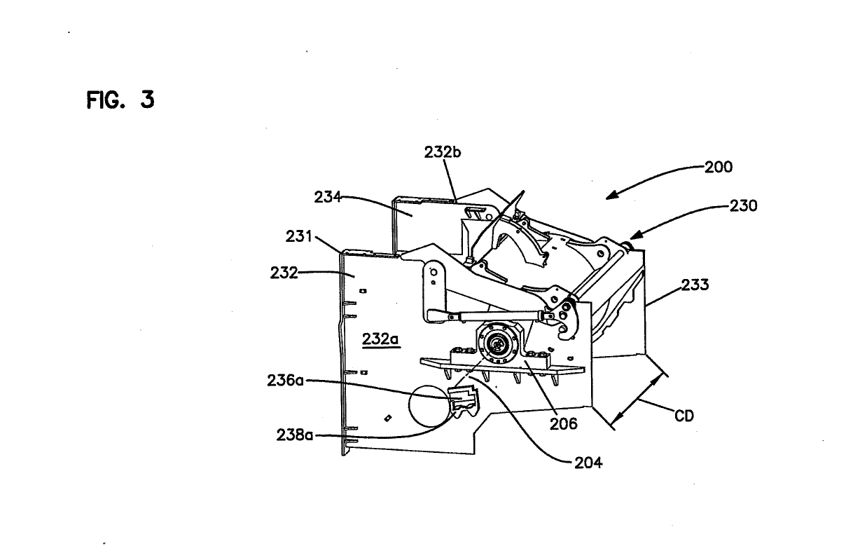

Referring to FIGS. 2-4, the reduction apparatus 200 includes a mill box 230 configured to support the rotational reducing component 201 and the sizing screen 210. The mill box 230 cooperates with the screen 210 to enclose the reducing chamber 205 of the reducing apparatus 200. As shown at FIG. 3, the mill box 230 includes a front end 231 positioned opposite from a back end 233 a first side 232a (e.g., a left side) positioned opposite from a second side 232b (e.g., a right side). The rotary drum 202 and the screen 210 are positioned between the sides 232a, 232b. First and second bearings 206 (only one is shown) are respectively mounted to the first and second sides 232a, 232b. The bearings 206 are adapted to receive a shaft of the rotary drum 202 for allowing the rotary drum 202 to rotate about the axis of rotation 204. A cross-dimension CD defined between the sides 232a, 232b of the mill box 230 is approximately equal to the length of the rotary drum 202.

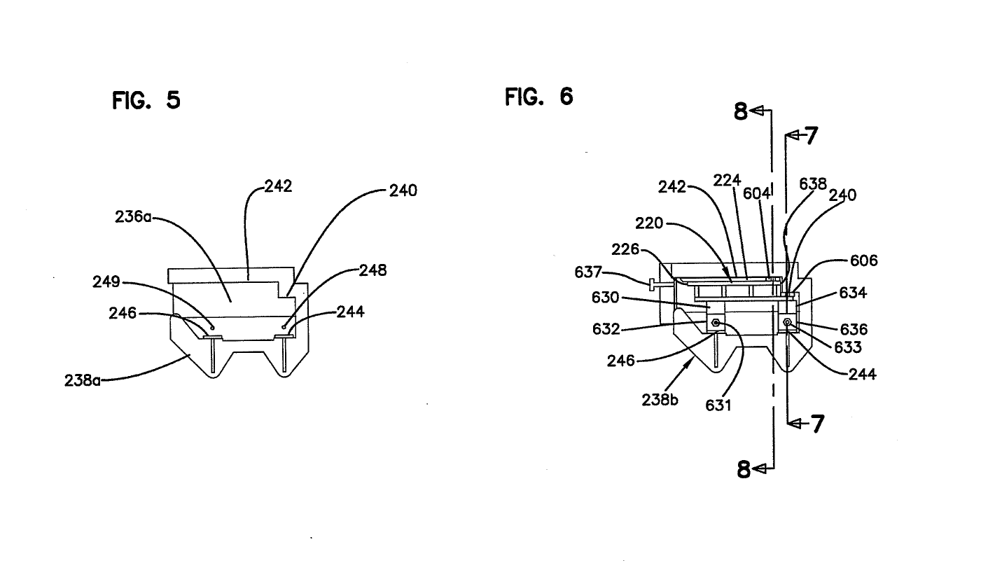

Referring to FIGS. 3 and 5-8, the mill box 230 include anvil receptacles 236a, 236b (i.e., anvil pockets or apertures) defined by anvil support structures 238a, 238b respectively incorporated into the sides 232a, 232b of the mill box 230. The anvil support structures are separated from one another by the cross-dimension CD of the mill box 230. The anvil support structures 238a, 238b have the same constructions. Referring to FIGS. 5 and 6, the anvil support structure 238b is depicted as including first and second upper support surfaces 240, 242, a first bottom support surface 244 that opposes the first upper support surface 240 and second bottom support surface 246 that opposes the second upper support surface 242. Threaded apertures 248, 249 are defined by the sides 232a, 232b. The threaded apertures 248, 249 extend in a direction parallel to the axis of rotation 204 of the rotary drum 202 and the cross-dimension CD of the mill box 230. The threaded apertures 248 are positioned between the first upper support surfaces 240 and the first bottom support surfaces 244. The threaded apertures 249 are positioned between the second upper support surfaces 242 and the second bottom support surface 246.

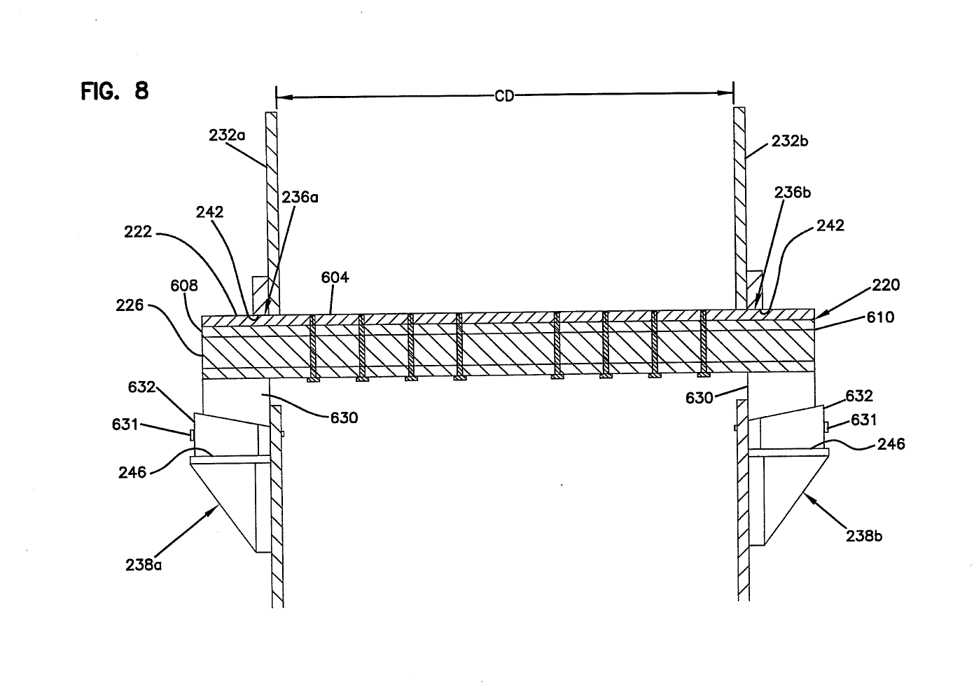

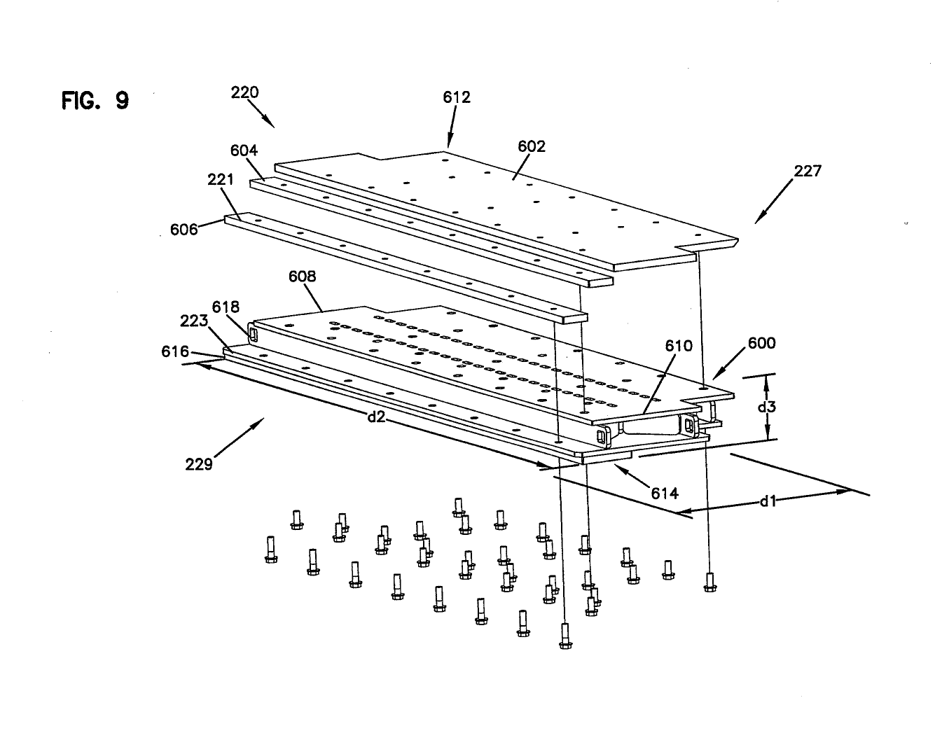

Referring to FIG. 9, the anvil unit 220 includes an assembly of components/parts that are fastened or otherwise connected together such that the anvil unit 220 can be loaded into the mill box 230 as a unit, and can be removed from the mill box 230 as a unit. The anvil unit 220 includes an anvil main body 600, a main top wear plate 602, a first shear edge defining plate 604 and a second shear edge defining plate 606. The anvil unit 220 has first and second ends 227, 229 (e.g., an in-feed end/front end and a reducing apparatus end/rear end) separated by the first dimension d1 (e.g., a width). The anvil unit 220 also includes third and fourth ends 608, 610 (e.g., left and right ends) separated by a second dimension d2 (e.g., a length). The anvil unit 220 further includes top and bottom sides 612, 614 separated by a third dimension d3 (e.g., a height or thickness). The dimensions d1-d3 are perpendicular relative to one another. When the anvil unit 220 is mounted in the mill box, the first dimension d1 extends between the in-feed system 110 and the reducing apparatus 200, and the second dimension d2 extends along the cross-dimension CD of the mill box. The dimension d2 is preferably longer than the cross-dimension CD such that the third and fourth ends 608, 610 can project through the anvil receptacles 236a, 236b at the left and right sides 232a, 232b of the mill box. This allows the ends 608, 610 to be clamped to the mill box 230 at locations outside the interior of the mill box 230.

In certain embodiments, the first and second shear edges of a given anvil unit are not adjustable in position relative to each other. Also, in certain embodiments, the shear edges of a given anvil unit are not adjustable in position within the mill box.

As indicated previously, the top side 612 of the anvil unit 220 forms the ramp 231 that bridges the gap between the power in-feed system 110 and the reducing apparatus 200. The anvil unit 220 defines a shelf 616 at the second end 229 which is vertically offset between from the top side 612 of the anvil unit 220 by a step 618. The main top wear plate 602 and the first shear edge defining plate 604 are mounted (e.g., fastened with removable fasteners such as bolts) at the top side 612 of the anvil unit 220. The wear plate 602 and the first shear edge defining plate 604 cooperate to define a wear surface of the ramp 231. The second shear edge defining plate 606 is mounted (e.g., fastened with removable fasteners such as bolts) to the shelf 616. The step 618 downwardly offsets the first shear edge defining plate 604 from the second shear edge defining plate 606. The first shear edge defining plate 604 defines the first shear edge 221 of the anvil unit 220 and the second shear edge defining plate 606 defines the second shear edge 223 of the anvil unit 220.

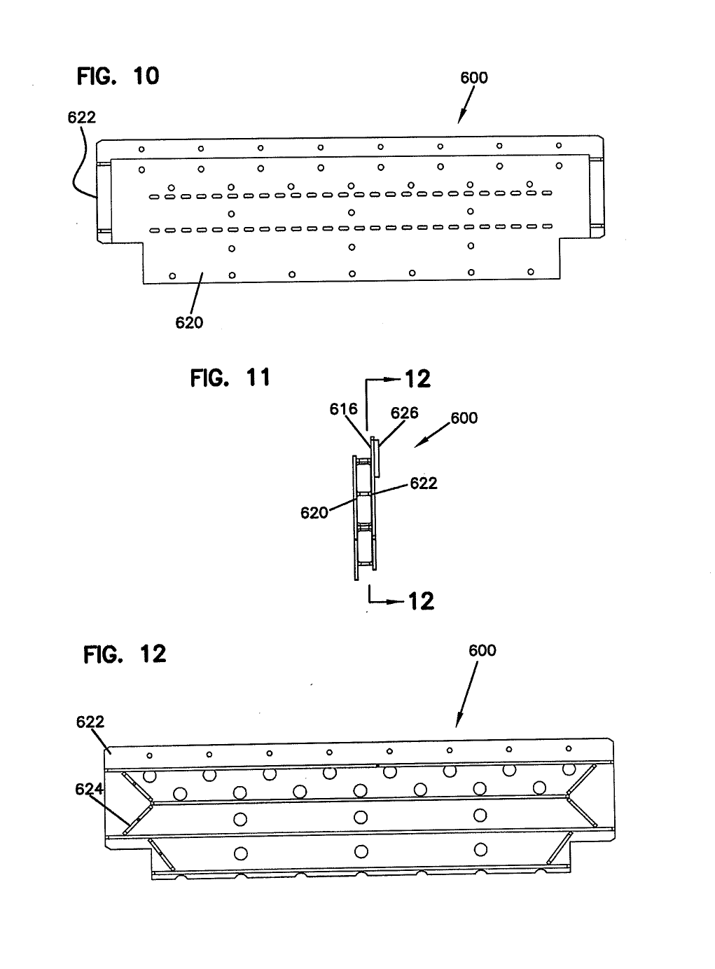

Referring to FIGS. 10-12, the anvil main body 600 includes an upper plate 620 vertically spaced from a lower plate 622. A plurality of interconnect plates 624 are secured between the upper and lower plates 620, 622 (see FIG. 12). The wear plate 602 and the first shear edge defining plate 604 are mounted to a top surface of the upper plate 620 by fasteners. The second shear edge defining plate 606 is mounted by fasteners to an upper surface of an end portion of the lower plate 622 that projects outwardly beyond the upper plate 620. A reinforcing plate 626 is mounted to the underside of the lower plate 622 at a location beneath the shelf 616.

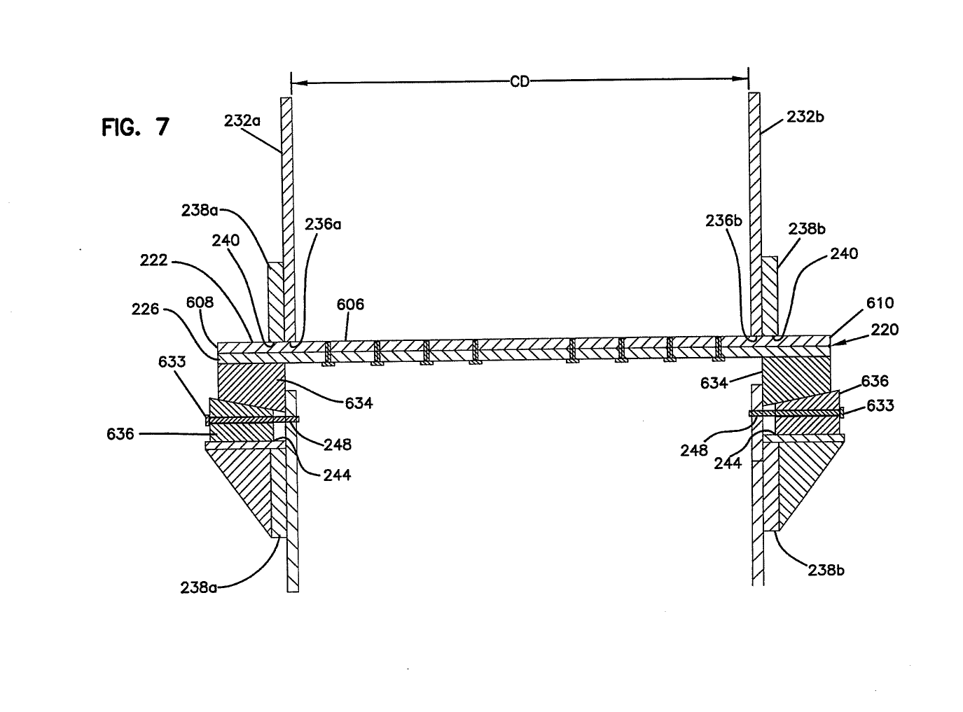

The anvil main body 600, the wear plate 602, the first shear edge defining plate 604 and the second shear edge defining plate 606 all define the dimension d2 that is greater than the cross dimension CD defined between the side walls 232a, 232b of the mill box. As shown at FIGS. 7 and 8, when the anvil unit 220 is mounted to the mill box 230, the ends 608, 610 of the anvil unit 220 project outwardly through the anvil receptacles 236a, 236b to locations positioned outside the interior of the mill box 230. Clamping arrangements are used to clamp the ends 608, 610 of the anvil unit 220 in position relative to the mill box 230. For example, left and right end portions of the wear plate 602, the anvil main body 600 and the first shear edge defining plate 604 are clamped against the first upper surfaces 240 of the anvil receptacles 236a, 236b by wedges 630, 632 that are seated against the first bottom surfaces 244 of the anvil receptacles 236a, 236b. Fasteners such as bolts 633 extend through the wedges 634, 636 and engage the threaded apertures 248 to pull the wedges 634, 636 into ramped engagement with one another thereby generating a clamping load for clamping the anvil unit 220 in place. Also, left and right end portions of the lower plate 622 and the second shear edge defining plate 604 are clamped between the second upper surfaces 242 and wedges 630, 632 that are seated against the second bottom surfaces 246 of the anvil receptacles 236a, 236b. Fasteners such as bolts 631 extend through the wedges 632 and engage the threaded apertures 249 to pull the wedges 630, 632 into ramped engagement with one another thereby generating a clamping load for clamping the anvil unit 220 in place. As shown at FIG. 6, other fasteners 637 can be used to force the anvil unit 220 against downstream stops 638 defined by the mill box 230 adjacent the rotational reducing component 201.

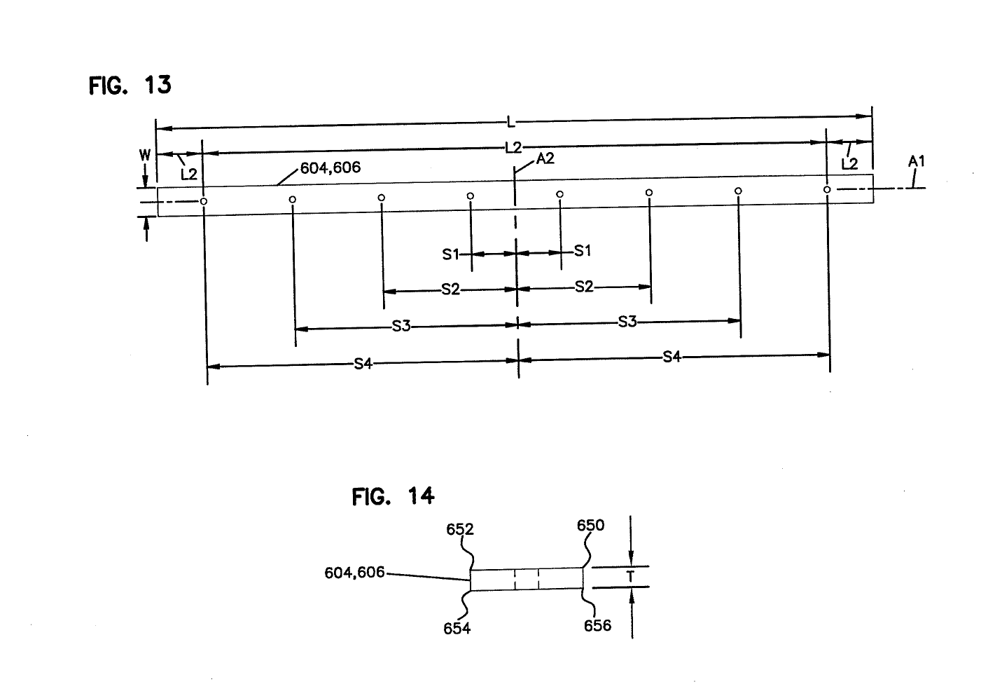

To load an anvil unit 220 into the mill box 230, the sets of wedges 630, 632, 634 and 636 are removed from each of the anvil receptacles 236a, 236b. Also, any covers or other structures that might typically enclose outer sides of the anvil receptacles 236 are removed. Thereafter, the anvil unit is slid along its length across the cross-dimension CD of the mill box 230 so that one end 608 of the anvil unit is received within the anvil receptacle 236a and the opposite end 610 is received in the second anvil receptacle 236b. The sets of wedges are then fastened within each of the anvil receptacles 236a, 236b causing the anvil unit 220 to be clamped within the anvil receptacles 236a, 236b. Also, the fasteners 637 can be tightened to force the anvil unit 220 against the stops 638 of the mill box. Referring to FIG. 13, each of the first and second shear edge-defining plates 604, 606 is preferably symmetrical about both a lengthwise axis Al and a widthwise axis A2. Each of the shear edge-defining plates 604, 606 is depicted as having a rectangular planform and a rectangular transverse cross-sectional shape having first, second, third and fourth corners 650, 652, 654 and 656 each defining a shear edge. The four corner configuration combined with the symmetrical nature of the shear edge-defining plates 604, 606 allows the plates 604, 606 to be flipped over about the axis A1 and to be flipped end-to-end about the axis A2 so as to allow each of the corners 650, 652, 654 and 656 to be used individually as an active shear edge of the anvil unit 220. For example, initially the plate can be oriented such that the first corner 650 functions as an active shear edge. When the first corner 650 becomes worn, the plate can be flipped about the axis A2 relative to the main anvil body 602 so that the fourth corner 656 becomes the active shear edge. Thereafter, when the fourth corner 656 becomes worn, the plate can be flipped about the axis A1 relative to the main anvil body 602 to make the second corner 652 the active shear edge. When the second corner 652 becomes worn, the plate can again be flipped about the axis A2 relative to the main anvil body 602 such that the third corner 654 becomes the active shear edge. The plates 604, 606 are preferably mounted to the anvil base 502 using a removable connection such as an arrangement of bolts.

Referring to FIGS. 13 and 14, each of the plates 604, 606 has a length L of at least 64 inches, a width W in the range of 2.5-3.5 inches, and a thickness T in the range of 0.5-1.0 inches. Also, each of the plates 604, 606 is preferably made of a hardened material such as abrasion resistant steel. The bolt holes through the plates 604, 606 correspond to a tap size of ⅝-11 UNC.

Referring to FIG. 13, each of the plates 604, 606 has an aperture defining region having a length L₂ in the range of 55-70 inches. As depicted, eight bolt apertures are defined through the aperture region. FIG. 7 shows how the second shear edge-defining plate 606 is fastened to the shelf 616 by bolts and FIG. 8 shows how the first shear edge-defining plate 604 is attached to the top plate of the main anvil body 602 by bolts. Bolt heads of the bolts are positioned beneath an underside of the main anvil body 602 so as to be protected from wear.

The plates 604, 606 can also include end clamping regions through which bolt holes are not defined. In certain embodiments, the end clamping regions have lengths L₂ in the range of 2-5 inches. The end clamping regions are preferably sufficiently long to project outwardly through the anvil receptacles such that the outer clamping portions can be clamped by the wedges at a location outside the interior of the mill box.

Referring to FIGS. 13 and 14, the apertures defined by the plates 604, 606 are positioned along the axis A₁ at positions offset from the axis A₂. For example, the first pair of opening positioned on opposite sides of the axis A₂ and are each spaced a distance S₁ from the axis A₂. Similarly, a second pair of the bolt openings are positioned on opposite sides of the axis A₂ and are spaced a second distance S₂ from the axis A₂. Similarly, a third pair of the bolt openings are positioned on opposite sides of the axis A₂ and are spaced at a distance S₃ from the axis A₂. Finally, a fourth pair of bolt openings are positioned on opposite sides of the axis A₂ and are spaced at a distance S₄ from the axis A₂. In certain embodiments, S₁ equals 4.75 inches, S₂ equals 14.25 inches, S₃ equals 23.75 inches and S₄ equals 33.25 inches. In certain embodiments, the overall length of the plates 604, 606 can be about 76.3 inches.

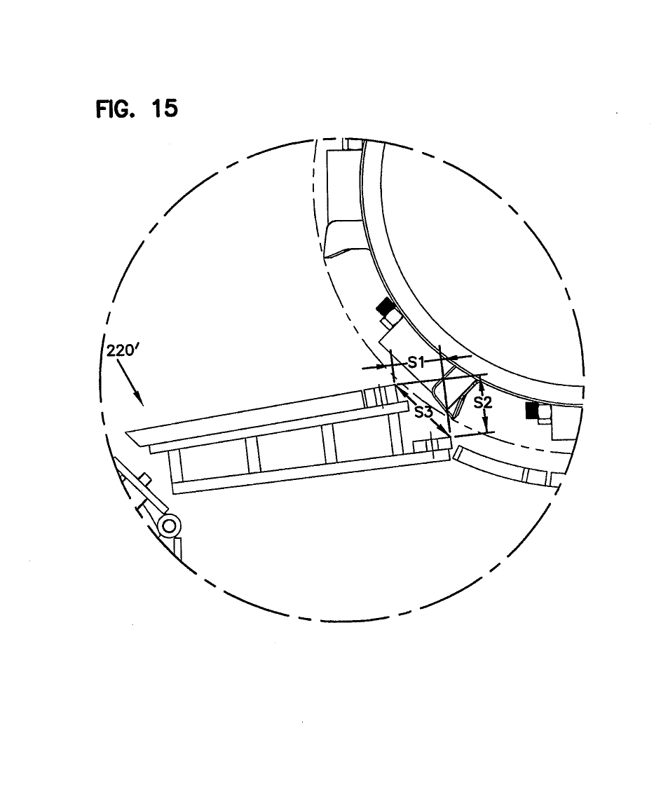

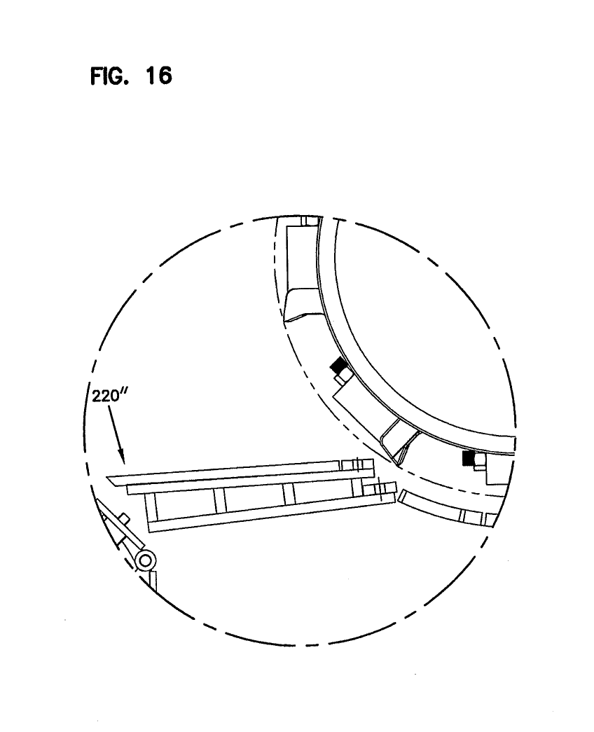

In certain embodiments, multiple different anvil units that can be interchangeably inserted into the mill box and removed from the mill box as units. The different anvil units can be configured to provide the reducing machine with different types of reducing characteristics. In certain embodiments, the different anvil units can have different spacing distances between their respective active first and second shear edges. In other embodiments, the different anvil units can be configured to position one or more of the active shear edges radially adjacent to different shear locations along the circumferential reducing path RP of the rotational reducing component. FIGS. 15 and 16 show two additional anvil units 220′, 220″ each having a different shear edge configuration. Each of the anvil units 220, 220′ and 220″ can be separately/individually mounted within the mill box. In all three of the anvil units 220, 220′, 220″, the second shear edges are adapted to be positioned at about the same locations along the circumferential reducing path RP of the rotational reducing component. However, in each of the anvil units 220, 220′, 220″, the first shear edges are positioned at different spacing distances S3 from their respective second shear edges. In certain embodiments, the spacing distances S1 are different, or the spacing distances S2 are different, or both of the spacing distances S1 and S2 are different. For certain applications, a plurality of additional interchangeable anvil units can each have a single shear edge with the anvil units being configured such that the shear edges of the anvil units define different shear locations along the circumferential reducing path RP of the rotational reducing component when the anvil units are individually mounted in the mill box.

It will be appreciated that each of the anvil units 220, 220′ and 220″ are compatible with the mill box 230 and have ends that can project through the anvil receptacles 236a, 236b and can be clamped to the mill box 230 at locations outside the interior of the mill box. The ends of the anvil units 220, 220′ and 220″ are compatible with the anvil receptacles 236a, 236b. In certain embodiments, different styles/shapes of wedges and or shims can be used with each of the anvil units 220, 220′ and 220″ to clamp the ends of such anvil units at desired positions within the anvil receptacles 236a, 236b. In certain embodiments, the anvil units 220, 220′ and 220″ have lengths longer than the cross-dimension CD of the mill box.

What is claimed is:

1. An anvil unit that can be inserted into a mill box of a reducing machine and removed from the mill box as a unit, the anvil unit comprising:
an anvil main body including left and right ends separated by a first dimension, the anvil body also including first and second ends separated by a second dimension, the anvil body further including top and bottom sides separated by a third dimension, the first, second and third dimensions being perpendicular to one another;
a ramp positioned at the top side of the anvil main body that extends in a first direction from the first end of the anvil main body to the second end of the main body;
a first shear edge that extends between the left and right ends of the anvil main body, the first shear edge being positioned at the second end of the anvil main body; and
a second shear edge that extends between the left and right ends of the anvil main body, the second shear edge being positioned at the second end of the anvil main body, the second shear edge being downwardly offset from the first shear edge, the second shear edge also being offset in the first direction from the first shear edge.

2. The anvil unit of claim 1, wherein the anvil main body defines a shelf positioned at the downstream end of the anvil main body, wherein the shelf has a length that extends between the left and right ends of the anvil main body, wherein the anvil main body defines a step that downwardly offsets the shelf from the ramp, and wherein the second shear edge is positioned adjacent the ramp and the second shear edge is positioned adjacent the shelf.

3. The anvil unit of claim 1, wherein a wear plate and a first shear edge defining plate are fastened to the top side of the anvil main body, wherein a second shear edge defining plate is fastened to the shelf of the anvil main body, wherein the wear plate and the first shear edge defining plate cooperate to define a wear surface of the ramp, wherein the first shear edge defining plate defines the first shear edge and wherein the second shear edge defining plate defines the second shear edge.

4. The anvil unit of claim 3, wherein the first and second shear edge defining plates are each bolted to the anvil main body, wherein the first and second shear edge defining plates each has a rectangular transverse cross-sectional shape defining four corners, wherein the corners define edges that extend along lengths of the plates, wherein the first shear edge defining plate is mounted to the main anvil body at a first mounting location, wherein the second shear edge defining plate is mounted to the main anvil body at a second mounting location, wherein the first shear edge defining plate can be bolted to the first mounting location in four different orientations with a different one of the edges of the first shear edge defining plate serving as the first shear edge in each of the four different orientations, and wherein the second shear edge defining plate can be bolted to the second mounting location in four different orientations with a different one of the edges of the second shear edge defining plate serving as the second shear edge in each of the four different orientations.

5. The anvil unit of claim 4, wherein each of the first and second shear edge defining plates has a length greater than 70 inches, a thickness in the range of 0.5-1.0 inches and a width in the range of 2.5-3.5 inches, wherein the first and second shear edge defining plates define major axes that extend along their lengths and minor axis that extend along their widths, wherein the first and second shear edge defining plates define internally threaded bolt openings that extend through the thicknesses of the first and second shear edge defining plates aligned along the major axes of the first and second shear edge defining plates, the threaded bolt openings being arranged symmetrical about the major axes and the minor axes.

6. The anvil unit of claim 1, wherein the reducing machine includes a power in-feed an a rotary reducing component, wherein the mill box of the reducing machine has a cross-dimension that is parallel to an axial of rotation of the rotary reducing component, wherein the anvil unit mounts to the mill box with the first dimension of the anvil main body parallel to the cross-dimension of the mill box, wherein the first dimension of the anvil main body is longer than the cross-dimension of the mill box, and wherein the second dimension of the anvil main body is sized such that the anvil main body is adapted to substantially bridge a gap between the rotary reducing component and the power in-feed of the reducing machine.

7. A replaceable component for defining a shear edge of an anvil used with a grinding machine having a mill box, the replaceable component comprising:
a plate having a rectangular transverse cross-sectional shape defining first, second, third and forth corners, the plate having a length of at least 70 inches, a width in the range of 2.5-3.5 inches and a thickness in the range of 0.5-1.0 inches, the plate being made of steel, the first, second, third and forth corners respectively defining first, second, third and fourth edges that extend along the length of the plate, the plate including a central region positioned between end regions, the end regions being adapted to be clamped in the grinding machine at locations outside the mill box and the central region defining a plurality of bolt openings for use in bolting the plate to the anvil, the plate defining a major axis that extends along the length of the plate and a minor axis that extends along the width of the plate, the bolt openings extending through the thickness of the plate, the bolt openings being symmetric about the major and minor axes of the plate such that the plate can be mounted at a mounting location of the anvil in first, second, third and fourth orientations, wherein the first edge functions as a shear edge of the anvil when the plate is mounted in the first orientation, wherein the second edge functions as the shear edge of the anvil when the plate is mounted in the second orientation, wherein the third edge functions as the shear edge of the anvil when the plate is mounted in the third orientation, wherein the fourth edge functions as the shear edge of the anvil when the plate is mounted in the fourth orientation.

8. The replaceable component of claim 7, wherein the bolt openings correspond to a tap size of ⅝-11 UNC.

9. The replaceable component of claim 7, wherein the plurality of bolt openings include first, second, third, fourth, fifth, sixth, seventh and eighth bolt openings aligned along the major axis, the first, second, third and fourth bolt openings being positioned on a first side of the minor axis and the fifth, sixth, seventh and eighth bolt openings being positioned on a second side of the minor axis, the first and fifth bolt openings having centers spaced 4.75 inches from the minor axis, the second and sixth bolt openings having centers spaced 14.25 inches from the minor axis, the third and seventh bolt openings having centers spaced 23.75 inches from the minor axis and the fourth and eighth bolt openings having centers spaced 33.25 inches from the minor axis.

10. A method for making a replaceable component for defining a shear edge of an anvil used with a grinding machine having a mill box, the mill box having a cross-dimension, the method comprising:
making a plate having a rectangular transverse cross-sectional shape defining first, second, third and forth corners, the plate having a length selected to be larger than the cross-dimension of the mill box, a width in the range of 2.5-3.5 inches and a thickness in the range of 0.5-1.0 inches, the plate being made of steel, and the first, second, third and forth corners of the plate respectively defining first, second, third and fourth edges that extend along the length of the plate; and
forming a plurality of bolt opening through the thickness of the plate, the bolt openings being symmetric about major and minor axes of the plate such that the plate can be mounted at a mounting location of the anvil in first, second, third and fourth orientations.

11. A reducing machine comprising:
a rotational reducing component including a reducing element carrier that is rotated about a central axis of rotation, the reducing element carrier carrying a plurality of reducing elements that are moved along a circumferential reducing path as the reducing element carrier is rotated about the central axis of rotation;
a power in-feed system for feeding material toward the rotational reducing component;
a mill box at least partially surrounding the rotational reducing component; and
an anvil unit that can be inserted into the mill box and removed from the mill box, the anvil unit including a ramp that bridges a gap between the power in-feed and the rotational reducing component, the anvil unit including an anvil main body having a first end positioned adjacent the power in-feed and a second end positioned adjacent the rotational reducing component, the anvil unit also including first and second spaced-apart shear edges positioned adjacent to the second end of the anvil main body, wherein the first and second shear edges cooperate with the rotational reducing component to provide consecutive shearing actions as the reducing elements move initially past the first shear edge and then subsequently past the second shear edge.

12. The reducing machine of claim 11, wherein the reducing element carrier comprises a rotary drum and the reducing elements comprising reducing teeth carried by the rotary drum.

13. The reducing machine of claim 11, wherein the anvil unit includes first and second shear edge defining plates bolted to the anvil main body, the first shear edge defining plate defining the first shear edge of the anvil unit and the second shear edge defining plate defining a second shear edge of the anvil unit, the second shear edge being downwardly offset from the first shear edge, the second shear edge also being offset in a first direction from first shear edge, the first direction extending from the power in-feed toward the reducing element carrier.

14. The reducing machine of claim 13, wherein the anvil main body defines a lower shelf at the downstream end of the anvil main body, and wherein the second shear edge defining plate is bolted to the shelf.

15. The reducing machine of claim 14, wherein anvil main body includes a top side, wherein a wear plate is bolted to the top side of the anvil main body, wherein the first shear edge defining plate is bolted to the top side of the anvil main body, and wherein the wear plate and the first shear edge defining plate cooperate to define a wear surface of the ramp of the anvil unit.

16. The reducing machine of claim 15, wherein the first and second shear edge defining plates each have a rectangular transverse cross-sectional shape defining four corners, wherein the corners define edges that extend along lengths of the plates, wherein the first shear edge defining plate is mounted to the main anvil body at a first mounting location on the top side of the anvil main body, wherein the second shear edge defining plate is mounted to the main anvil body at a second mounting location on the shelf of the anvil main body, wherein the first shear edge defining plate can be bolted to the first mounting location in four different orientations with a different one of the edges of the first shear edge defining plate serving as the first shear edge in each of the four different orientations, and wherein the second shear edge defining plate can be bolted to the second mounting location in four different orientations with a different one of the edges of the second shear edge defining plate serving as the second shear edge in each of the four different orientations.

17. A reducing machine system comprising:
a rotational reducing component including a reducing element carrier that is rotated about a central axis of rotation, the reducing element carrier carrying a plurality of reducing elements that are moved along a circumferential reducing path as the reducing element carrier is rotated about the central axis of rotation;
a power in-feed system for feeding material toward the rotational reducing component;
a mill box at least partially surrounding the rotational reducing component; and
first and second anvil units that can be interchangeably inserted into the mill box and removed from the mill box as units, the first and second anvil units each including a ramp configure to bridge a gap between the power in-feed and the rotational reducing component, the first and second anvil units each including at least a first shear edge, the first anvil unit being configured such that the first shear edge of the first anvil unit defines a first shear location along the circumferential reducing path when the first anvil unit is mounted in the mill box, the second anvil unit being configured such that the first shear edge of the second anvil unit defines a second shear location along the circumferential reducing path when the second anvil unit is mounted in the mill box, the first and second shear locations being circumferentially offset from one another such that the first and second shear edges provide different reducing characteristics.

18. The reducing machine of claim 17, wherein the first and second anvil units also include a second shear edges spaced from the first shear edges, the first and second shear edge of each of the first and second anvil units being configured to cooperate with the rotational reducing component to provide consecutive shearing actions as the reducing elements move initially past the first shear edge and then subsequently past the second shear edge.

19. The reducing machine of claim 18, where a first spacing distance is provided between the first and second shear edges of the first anvil unit and a second spacing distance is provided between the first and second shear edges of the second anvil unit, the first spacing distance being different from the second spacing distance.
